(19) United States
(12) Patent Application Publication
(10) Pub. No.: US 2012/0316936 A1
(43) Pub. Date: Dec. 13, 2012

(54) INTEGRATED LOYALTY PROGRAM INFRASTRUCTURE

(76) Inventor: Philip Clifford JACOBS, Windham, NH (US)

(21) Appl. No.: 13/155,070

(22) Filed: Jun. 7, 2011

(51) Int. Cl. G06Q 30/00

(52) U.S. Cl. 705/14.16

(57) ABSTRACT

In accordance with an example embodiment, there is disclosed herein a loyalty program directed to consumers of media content such as television. A member of the loyalty program receives rewards for various pre-defined activities. The rewards can be accumulated and redeemed at a future time.

### TECHNICAL FIELD

The present disclosure generally relates to loyalty a program for a consumers of media content such as television.

### BACKGROUND

Loyalty programs are used to try to influence consumers to stick with a brand and enable a loyalty program provider associated with the brand to obtain insights into a customer through loyalty program data. Often, loyalty programs will offer an award for participating in the program to entice consumer participation.

### BRIEF DESCRIPTION OF THE DRAWINGS

The accompanying drawings incorporated herein and forming a part of the specification illustrate the example embodiments.

FIG. 1 is a block diagram illustrating an example of a loyalty program infrastructure.

FIG. 2 is a block diagram illustrating an example of a loyalty program where award points are awarded by multiple brands for the same activity.

FIG. 3A is a block diagram illustrating a detailed example of a brand awards program controller for a single provider loyalty program architecture.

FIG. 3B is a block diagram illustrating a detailed example of a service provider infrastructure for a single provider loyalty program architecture.

FIG. 4A is a block diagram illustrating an example of a of a brand awards program controller for a multiple service provider architecture.

FIG. 4B is a block diagram illustrating an example of a first service provider infrastructure in a multiple service provider architecture.

FIG. 4C is a block diagram illustrating an example of a second service provider infrastructure in a multiple service provider architecture.

FIG. 5 is a block diagram of a computer system upon which an example embodiment may be implemented.

FIG. 6 is a block diagram of an example methodology for implementing a loyalty program.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a loyalty program directed to consumers of media content such as television. A member of the loyalty program receives rewards for various activities which can be redeemed at a future time.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, viewers consume media content and applications as they normally would on a television (TV), personal computer (PC), and/or a mobile device across multiple service providers. Viewers are notified that they can opt-in to a loyalty program and that once they have opted in certain viewer engagements will result in certain rewards. As viewers engage in predefined activities, they accumulate points which can be redeemed for rewards. Via the integrated loyalty program, brands can discover how viewers that opt-in engage with their content and applications across multiple devices and/or providers.

Some of the basic features of the program include:

1—Providing a unique household identification;

2—Provide reports of viewer engagements with content or applications;

3—The ability to filter reports to identify and validate engagements of interest;

4—The ability to steer reports to “Brands” award programs;

5—Aid in deciding whether to award/retire a viewer's points; and

6—Provide a means for the viewer communications with the awards program (e.g., to determine award status and/or redemption of awards).

Optionally, the program may include a recommendation engine that recommends personalized regards and pushes targeted promotions based on loyalty profiles. Another option is the support of federated brands. For example, the “Iron Chef” brand permits “Food channel” brand to also award points.

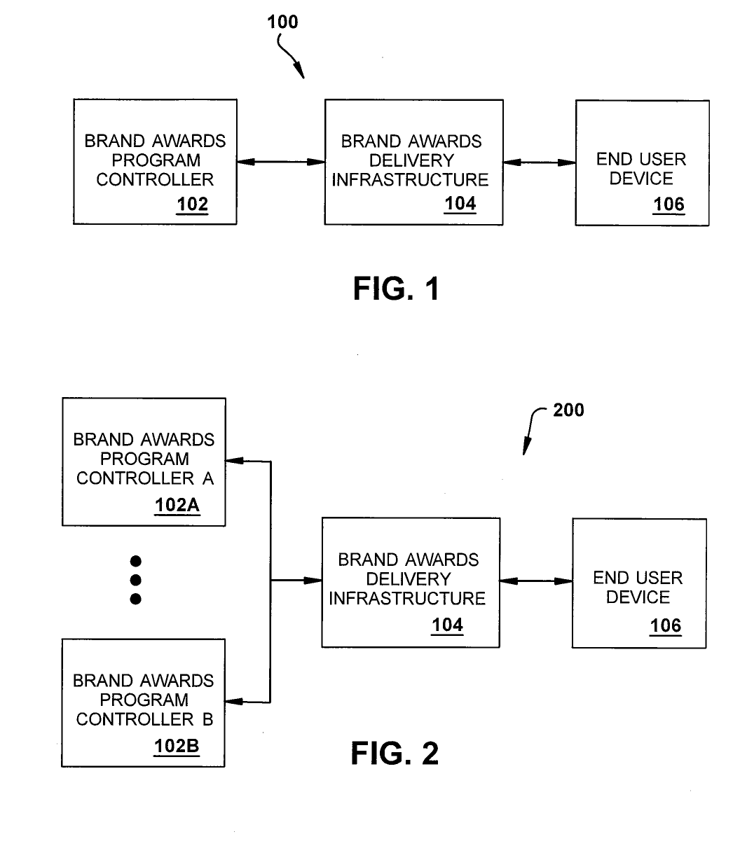

FIG. 1 is a block diagram illustrating an example of a loyalty program infrastructure 100. Loyalty program infrastructure 100 comprises a Brand Awards Program Controller (BAPC) 102, a brand awards delivery infrastructure 104 and an end user device 106.

Brand Awards Program Controller 102 provides the rules for validating user (or viewer) engagement activity to brand awards delivery infrastructure 104. BAPC 102 receives viewer activity reports from brand awards delivery infrastructure 104 and employs logic to calculate awards points. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software embodied on a non-transitory computer-readable medium that performs the described functionality when executed by processor.

Brand awards delivery infrastructure 104 suitably comprises logic for receiving loyalty program rules from BAPC 102 and viewer engagement activity data from end user device 106. Logic in brand awards delivery infrastructure 104 applies the rules received from BAPC 102 to the view engagement activity data received from end user device 106 to generate validated engagement reports which are forwarded to BAPC 102.

End user device 106 provides engagement measurement data to brand awards delivery infrastructure 104. End user device 106 receives the media and provides it to an end user. Some examples of end user device 106 include but are not limited to a television, a desktop computer, or portable computing device such as a laptop, smart phone, or tablet computer. In an example embodiment, end user device 106 comprises a user interface that allows an end user to select media content and communicate with BAPC 102, enabling the end user to obtain loyalty program award data such as accumulated points and/or to redeem points.

In an example embodiment, the logic for implementing brand awards delivery infrastructure 104 is part of end user device 106. For example, brand awards delivery infrastructure may be implemented in a software module embodied in user device 106.

In another example embodiment, the logic for implementing brand awards delivery infrastructure 104 is embodied on a separate, remote device from end user device 106. For example, in a network environment the logic for implementing brand awards delivery infrastructure 104 may be embodied on a server that is providing a media stream to end user device 106. End user device 106 provides engagement measurement and reporting data to brand awards delivery infrastructure 104.

In an example embodiment, at least one user of end user device 106 is assigned a user identifier upon joining the loyalty program associated with loyalty program infrastructure 100. In an example embodiment, the loyalty program may incorporate more than one brand (e.g., the loyalty program may actually comprise a plurality of loyalty programs, each may have separate rules for validating user engagement and/or awarding points). In an example embodiment, the same user identifier is employed to identify a user to all of the loyalty programs associated with loyalty program infrastructure 100. When a user joins a loyalty program with multiple brands, the user may be provided with data indicating that the user is joining a program related to multiple brands and is asked to verify their consent to opting in to all brands. In particular embodiments, the granularity of the user account may be varied. For example, a user account may be established for a household and/or for an individual.

In an example embodiment, Brand Awards Program Controller 102 receives data representative of user behavior or user engagement with predefined media content such as predefined television shows, movies, commercials, and/or other streaming media. For example based on data collected by end user device 106, brand awards controller 102 may determine whether the user watched a television program, interacted with the television program (for example provided responses via a user interface or remote control) and/or interact with non-program media applications such as questionnaires.

In an example embodiment, other loyalty program activity data may be provided to Brand Awards Program Controller 102. For example, a user may purchase media content and/or other services such as tickets employing end user device 106 or via other sources (not shown), for example from a predefined web site.

In an example embodiment, Brand Awards Program Controller 102 receives data representative of viewer engagement with a media from end user device 106 via brand awards delivery infrastructure 104. In an example embodiment that will be explained in more detail herein infra, end user device 106 sends raw engagement data to brand awards delivery infrastructure 104, which applies validation rules supplied by Brand Awards Program Controller 102 to produce a validated engagement report. The validated engagement report is forwarded by brand awards delivery infrastructure 104 to Brand Awards Program Controller 102 which employs the validated engagement report to calculate awards points. The data representative of viewer engagement may comprise type of service, for example whether the media was viewed in real-time, via a digital video recorder (DVR) or video on demand (VOD). In particular embodiments, the data representative of viewer engagement comprises data indicating the type of device employed to view the media such as a television, personal computer (PC), mobile device (e.g., smart phone, laptop, or tablet computer), game console, etc.

In an example embodiment, the data representative of viewer engagement comprises an identifier for the content of the media. The data representative of viewer engagement may further comprise position data indicating which portions of the content were viewed. For example, the position data may comprise data indicating whether certain portions were skipped, for example if commercials were fast forwarded. In an example embodiment, the data is indexed from the beginning of the media. In particular embodiments, the data representative of viewer engagement may suitably comprise an identifier for the content of an application associated with the media and/or position data.

In an example embodiment, the data representative of viewer engagement comprises measurement data. For example, the data may include involvement data such as how much time the viewer spent watching and/or whether the viewer is a frequent watcher. The measurement data may include interaction data such as whether there were requests to replay the content or requests made for other information. In particular embodiments, the measurement data may include data representative of user sentiment. For example, data about associated chat activities such as amount and words used. In an example embodiment, the measurement data may include promotional activities such as data indicating whether the viewer forwarded the content to friends or posted comments to a blog (web log).

In an example embodiment, the representative of viewer engagement comprises engagement validation data. In particular embodiments where multiple brands are involved, the validation data can be individualized for each brand.

For example, during the play out of media content awards marketing program may request the user enter in a code or select an “info” button to verify the viewer is present. In particular embodiments, the validation data contains data indicating whether the viewer viewed the entire content, or less than the entire content. For example, the engagement validation data may include whether a mute button was used or the display was minimized or obscured during play out of the media content. In addition, the validation data may comprise data indicating whether any media content was skipped or fast forwarded.

In an example embodiment, brand awards program controller 102 awards points based on viewer engagement activities. Points can be awarded for specific behaviors, which may also be validated. In particular embodiments, caps or limits may be placed on the points awarded for certain or any viewer behavior.

In an example embodiment, points may be awarded based on aggregate behavior. For example, viewing of a predefined number of episodes may be required before points are awarded (for example no points awarded if viewing less than n episodes, points are awarded once n episodes are viewed).

In an example embodiment points may be awarded based on a viewer's status. For example, viewers who consume a large amount of media content may be given a preferred status such as a silver or gold elite status. Elite status viewers may be awarded additional points (e.g., 1.5× points for silver elite and 2× points for gold elite).

In an example embodiment, points may be awarded based on the competitive live schedule. For example, a viewer watching live media content during a popular show (or special event such as the Super Bowl) may be awarded additional points.

In an example embodiment, points may be awarded based on ratings, such as current ratings or expected ratings. For example, bonus points may be awarded if a show's ratings share decrease in order to try to bolster the show's ratings.

In an example embodiment, points may be awarded based on viewing mode. For example, additional points may be awarded for watching a show live as opposed to watching a previously taped episode from a DVR.

In an example embodiment, points may be valid for a limited time period. For example, unused points older than a predefined time period (e.g., a year) can be purged.

In an example embedment, Brand Awards Program Controller 102 may be integrated with other external devices. This can enable brand awards program controller 102 to obtain data for offline or Over the top (OTT) behavior. Points may be awarded for certain offline or OTT behaviors.

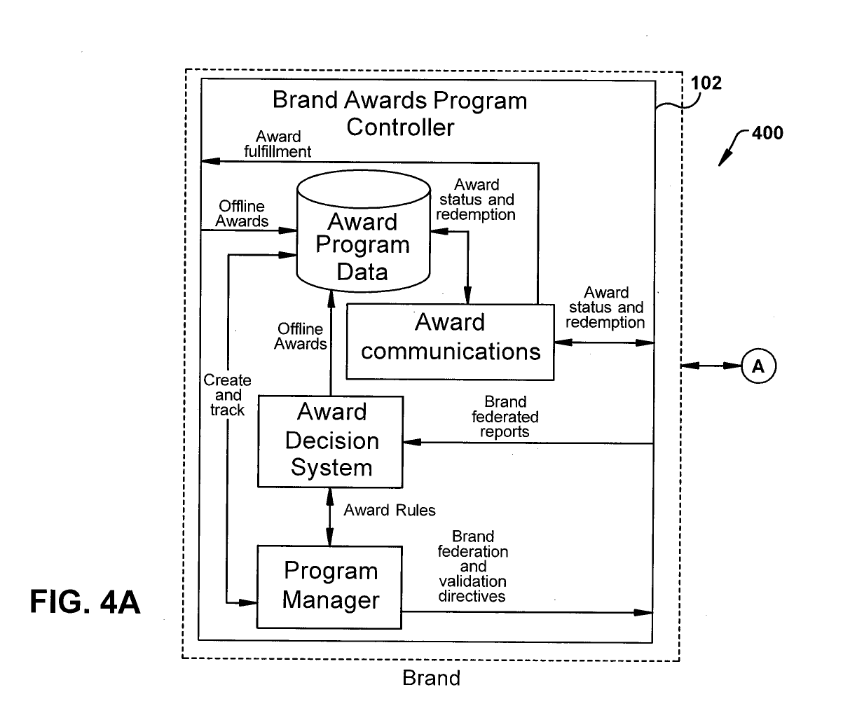

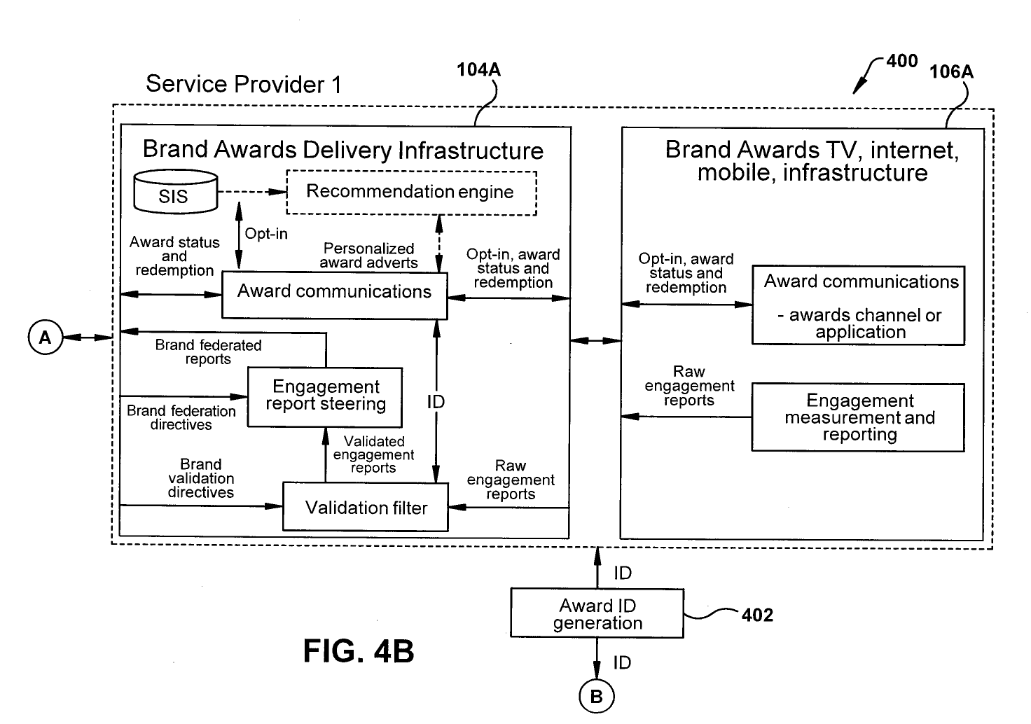

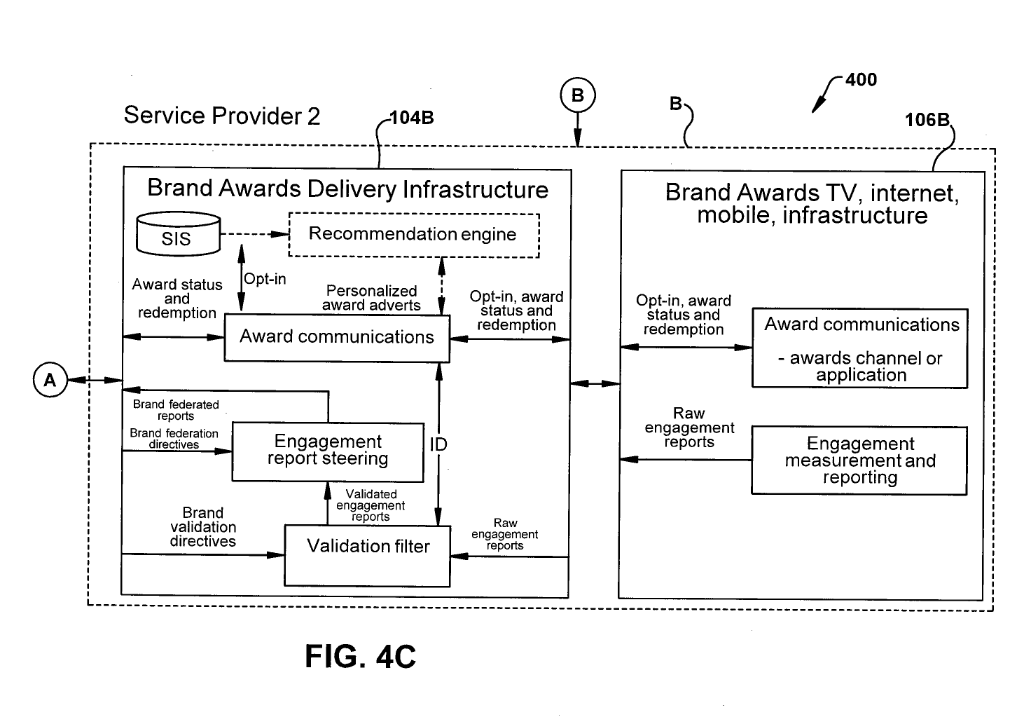

In an example embodiment, a viewer can receive award points from a plurality of brands for the same activity. For example, referring to FIG. 2 with continued reference to FIG. 1, there is illustrated an example of a loyalty program infrastructure 200 where award points are awarded by multiple brands for the same activity (see e.g., FIG. 4 for a more detailed description of an example embodiment that provides multiple brand awards). There are two brand award program controllers 102A, 102B in the example illustrated in FIG. 2. Those skilled in the art should readily appreciate that two brand award program controllers were selected merely for ease of illustration and that any physically realizable number of brand award program controllers may be employed in an example embodiment. The first Brand Awards Program Controller 102A corresponds to a first brand loyalty program, and second Brand Awards Program Controller 102B corresponds to a second brand loyalty program.

Brand Awards Program Controller 102A provides brand awards delivery infrastructure 104 with rules for validating viewer engagement with media for the first brand loyalty program. Brand Awards Program Controller 102B provides brand awards delivery infrastructure 104 with rules for validating viewer engagement with media for the second brand loyalty program. Thus, when brand awards delivery infrastructure 104 receives viewer engagement data from end user device 106, brand awards delivery infrastructure 104 can apply the rules provided by Brand Awards Program Controller 102A to provide a first validated viewer engagement report based on the rules of the first brand loyalty program to brand award program controller 102A, and can apply the rules provided by Brand Awards Program Controller 102B to provide a second validated viewer engagement report based on the validation rules of the second brand loyalty program to brand award program controller 102B. Brand Awards Program Controller 102A calculates awards points for the first brand awards loyalty program based on the first validated viewer engagement report. Brand Awards Program Controller 102B calculates awards points for the second brand awards loyalty program based on the second validated viewer engagement report.

In an example embodiment, at least one of the brand loyalty program points expire after a predefined time period. Because its brand loyalty program has its own Brand Awards Program Controller 102A, 102B, points may expire at different intervals for each brand loyalty program. For example, points awarded by Brand Awards Program Controller 102A may expire after one year, and points awarded by Brand Awards Program Controller 102B may never expire.

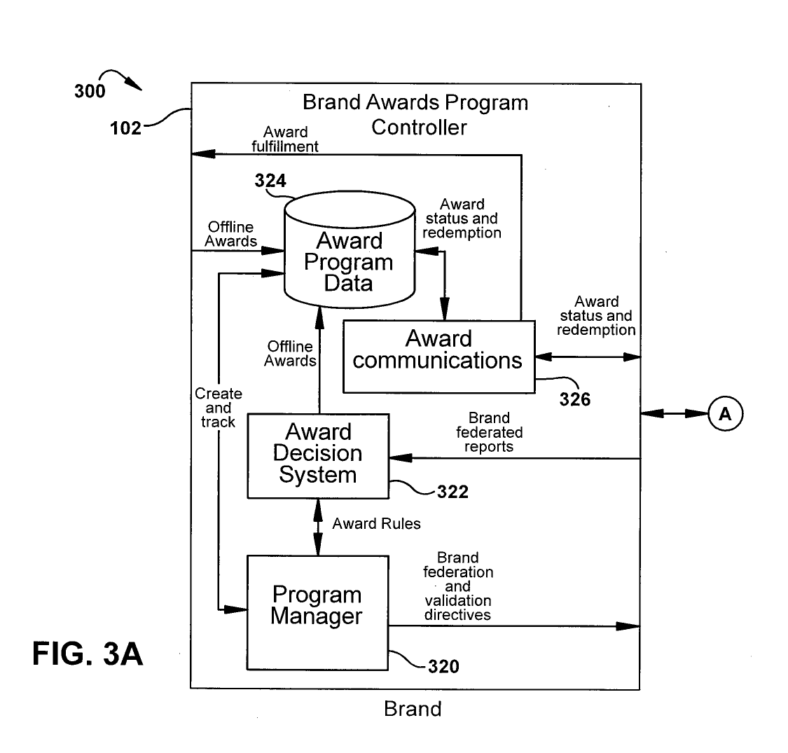

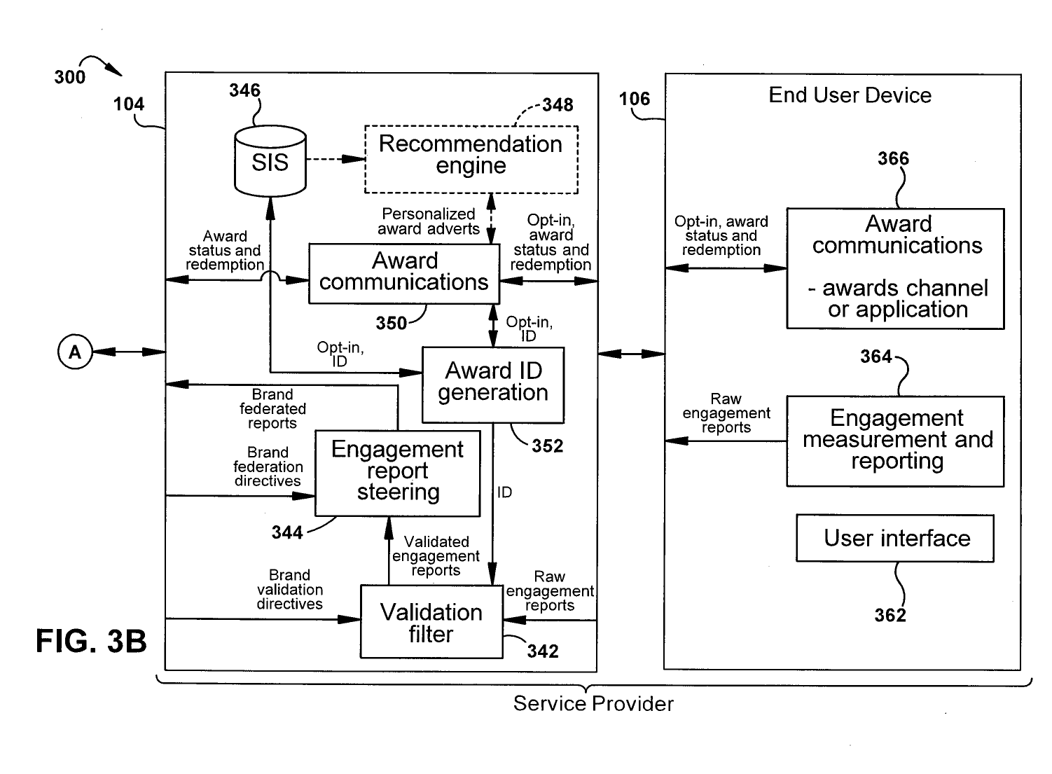

In an example embodiment, end user device 106 suitably comprises a user interface (not shown, see e.g., FIG. 3) for interacting with each individual brand loyalty program. For example, a television may provide a dedicated channel for interacting with Brand Awards Program Controllers 102A, 102B. For example, data may be displayed on the television screen while the user can input data via a remote control coupled with the television set. Computing devices may employ an application for enabling a user to access Brand Awards Program Controllers 102A, 102B. This can enable a member of the loyalty programs to learn about future potential awards, current awards status (points and/or elite status), and the user may receive advertisements of available awards. Optionally, the advertised available awards may include recommended items based on the user's profile and/or viewing habits.

The user interface may also be employed to enable the user to redeem awards points. In architecture with a multiplicity of loyalty programs, the user may be given an option to select a loyalty program.

In an example embodiment, the user can opt-in to the loyalty program infrastructure via the user interface. In particular embodiments, a user may be required to acknowledge participation in all loyalty programs affiliated with the architecture. The user may be assigned or select a password for communicating with the Brand Awards Program Controllers 102A, 102B for interacting with the subscribed loyalty programs. User accounts may be individual, family or a plurality of user accounts associated with a group such as a family, household, etc.

In an example embodiment, a subscriber may earn awards points for the same activity federated (related) loyalty programs. For example, if the subscriber watches an Iron Chef episode, the subscriber may earn awards points from Iron Chef, the Food Network, and/or local advertisers who advertised during the watched episode. Brand awards delivery infrastructure 104 may be provided with federated awards data and distribute validated engagement reports to the appropriate Brand Awards Program Controllers. Each Brand Awards Program Controller calculates points for the activity. For example, if BAPC 102A is associated with the Iron Chef television show and BAPC 102B is associated with the Food Network, when a subscriber watches an episode of Iron Chef, end user device 106 provides engagement data to brand awards delivery infrastructure 104. Brand awards delivery infrastructure 104 determines that the show qualifies for federated awards from the food network, so brand awards deliver infrastructure 104 generates a first validated engagement report based on rules associated with the Iron Chef loyalty program and a second validated engagement report based on rules associated with the Food Network loyalty program. The first validated engagement report is sent to BAPC 102A and the second validated engagement report is sent to BAPC 102B. BAPC 102A calculates awards points based for the Iron Chef loyalty program and BAPC 102B calculates awards for the Food Network loyalty program. Thus, a subscriber may receive a different number of points from each subscriber for the same activity. Terms of Federated loyalty programs may dictate who can award points (e.g., Iron Chef may award points separately or may permit the Food Network to award points), type of awards that may be awarded (e.g., number of points, gold points vs. silver points, etc.), which content and applications can be awarded points, who gets what engagement data, validation requirements (e.g., presence detection), and/or award rule caps (e.g., max per unit time or per engagement types).

FIG. 3 is a block diagram illustrating a detailed example of a single provider loyalty program architecture 300. In this example embodiment, a single service provider provides data to Brand Awards Program Controller 102.

FIGS. 3A and 3B illustrate a detailed example of a single provider loyalty program architecture 300 where FIG. 3A is a block diagram illustrating a detailed example of a brand awards program controller for a single provider loyalty program architecture, and FIG. 3B is a block diagram illustrating a detailed example of a service provider infrastructure for a single provider loyalty program architecture.

End user device 106 suitably comprises a user interface 362, an engagement and reporting module 364 and an awards communications module 366. User interface 362, reporting module 364 and awards communication module 366 may suitably comprise logic for implementing the functionality described herein.

User interface 362 provides a mechanism for enabling a subscriber to interact with a loyalty program. The user interface may suitably comprise a video output device such as a display, an audio output device such as a speaker, and an input device such as a remote control, keyboard, mouse, touch screen, etc.

Engagement and reporting module 364 monitors activity on end user device 106. Engagement and reporting module 364 provide raw engagement reports to brand awards delivery infrastructure 104. The raw engagement reports may include the activity (name of program watched or application subscriber engaged with), whether the subscriber interacted with the program when prompted (e.g., if the user was provided with a “press the select button now” message on the screen whether the user responded and optionally how long it took the user to respond), whether the user watched the entire program or completed an activity (for example filled out an entire questionnaire) or how much of the activity the user was engaged in, and/or whether any portions of the activity were muted, fast forwarded, skipped, the display screen was minimized, obscured, or the activity was viewed with a less than full screen window.

Awards communications module 366 provides an interface between the user and the loyalty program. The awards communications module may be a dedicated channel on a television set or an application. Awards communications module 366 communicates with brand awards delivery infrastructure 104 and enables a subscriber to opt-in to the loyalty program (or programs), obtain status and redemption information, and to enable the subscriber to redeem points.

Brand awards delivery infrastructure 104 comprises a validation filter 342 that receives raw engagement data from end user device 106. In addition, validation filter 342 receives brand validation directives (rules) from Brand Awards Program Controller 102. Validation filter 342 also receives a user identifier from award ID generation module 352. Award ID generation module 352 assigns a subscriber a user identifier responsive to the subscriber joining the loyalty program. In addition, the award ID generation module 352 creates an entry for the subscriber in Subscriber Information System (SIS) 346. Validation filter 342 generates validated engagement reports based on the raw engagement data and brand validation directives. The validated engagement reports are forwarded to the engagement report steering module 344.

Engagement report steering module 344 receives brand federation directives (rules) from Brand Awards Program Controller 102. Engagement report steering module 344 distributes the reports to the appropriate Brand Awards Program Controller 102 (in this example there is only one BAPC; however, see e.g., FIG. 2).

Brand awards deliver infrastructure 104 further comprises an awards communications module 350. Awards communications module 350 receives opt-in data, awards requests and redemption requests from user device 106 and provides them to Brand Awards Program Controller 102. Awards communications module 350 receives award, status and redemption data from Brand Awards Program Controller 102 and provides the data to end user device 106. Optionally, awards data may be personalized by a recommendation engine 348. Recommendation engine 348 may recommend certain awards to a subscriber based on a subscriber's profile, previously indicated preferences, and/or engagement activities.

Brand Awards Program Controller 102 comprises a program manager 320. Program manager 320 provides brand validation and brand federation directives to brand awards delivery infrastructure 104. Program manager 320 may also create and track awards program data stored in award program data module 324.

Award decision system 322 calculates the award points. The awards points are calculated based on brand federated reports received from brand awards delivery infrastructure 104 and award rules received from program manager 320. The calculated awards are supplied to award program data module 324.

Award communications module 326 communicates with brand awards delivery infrastructure 104. Awards communications 326 module provides award status data. Awards communications module 326 may also receive data indicating when points are being redeemed. Point redemption is award program data module 324 and in particular embodiments, communications for award fulfillment are handed by awards communication module 326.

In an example embodiment, award program data module 324 may receive award data from external sources (Offline Awards). For example, viewing activity is provided from user device 106 via brand awards delivery infrastructure 104. However, non-viewing activity, such as filing out of questionnaires, posting comments about the content, etc. may also be provided to award program data module 324.

FIGS. 4 A, 4B, and 4C illustrate an example of a multiple service provider architecture 400. FIG. 4A illustrates an example of a of a brand awards program controller for a multiple service provider architecture. FIG. 4B is a block diagram illustrating an example of a first service provider infrastructure in a multiple service provider architecture, and FIG. 4C is a block diagram illustrating an example of a second service provider infrastructure in a multiple service provider architecture.

Architecture 400 enables Brand Awards Program Controller to receive content engagement data from a plurality of sources. For example, user device 106A coupled with brand awards delivery infrastructure 104A may be a subscriber's home television set. User device 106B coupled with brand awards delivery infrastructure 104B can be a computing device associated with the subscriber such as a personal computer, smart phone, laptop, tablet, etc.

In an example embodiment, an award ID generation module 402 generates a universal user identifier for a new subscriber. The user identifier is provided to SIS modules 346 in brand delivery infrastructure 104A and 104B and to award program data module 324 in brand award program controller 102.

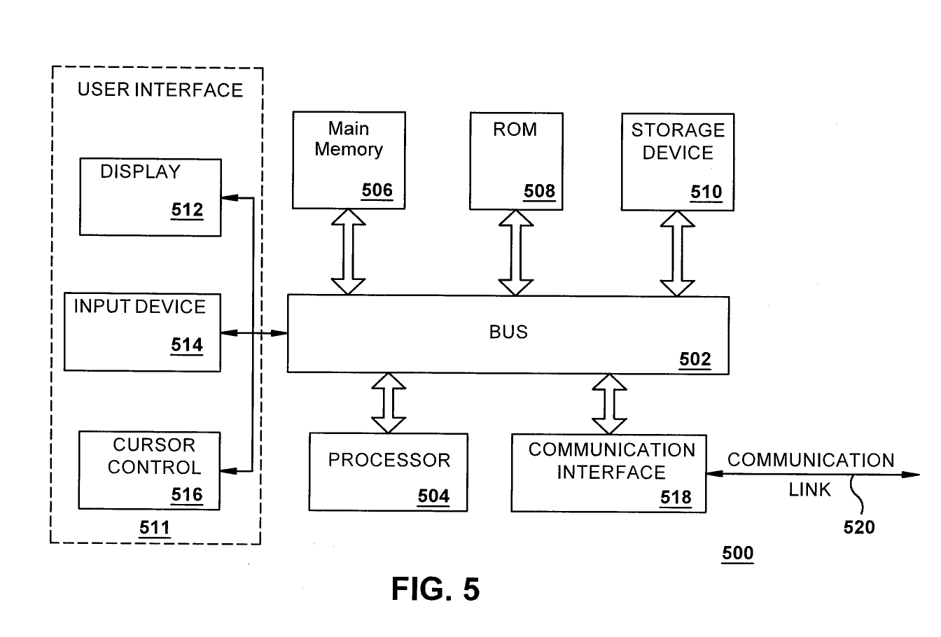

FIG. 5 is a block diagram of a computer system 500 upon which an example embodiment may be implemented. Computer system 500 may be employed to implement Brand Awards Program Controller 102 (FIGS. 1, 3 and 4) 102A, 102B (FIG. 2), brand awards delivery infrastructure 104 (FIGS. 1-3), 104A (FIG. 4), 104B (FIG. 4), end user device 106 (FIGS. 1-3), 106A (FIG. 4), 106B (FIG. 4), and/or awards identification generator 402 (FIG. 4).

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

In an example embodiment, for example if computer system 500 is being employed to implement end user device 106 (FIG. 3), computer system 500 comprises a user interface 511. For example, computer system 500 may be coupled via bus 502 to display 512 for displaying visual data. Display 512 may be any suitable type of display device such as a cathode ray tube (CRT) or liquid crystal display (LCD), or any other suitable display device for displaying information to a computer user. An input device 514, such as a keyboard including alphanumeric and other keys is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g. x) and a second axis (e.g. y) that allows the device to specify positions in a plane.

An aspect of an example embodiment is related to the use of computer system 500 for implementing a loyalty program. According to one embodiment, implementing the loyalty program is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media and/or volatile media. Non-volatile media include for example optical or magnetic disks, such as storage device 510. Volatile media include dynamic memory such as main memory 506. Common forms of computer-readable media include for example floppy disk, a flexible disk, hard disk, magnetic cards, optical storage, paper tape, any other physical medium with patterns of holes, a RAM, a PROM, an EPROM, a FLASHPROM, CD, DVD or any other memory chip or cartridge, or any other medium from which a computer can read.

Computer system 500 also includes a communication interface 518 coupled to bus 502. Communication interface 518 provides a two-way data communication coupling to a communication link 520 that can be employed to communicate with an external device. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

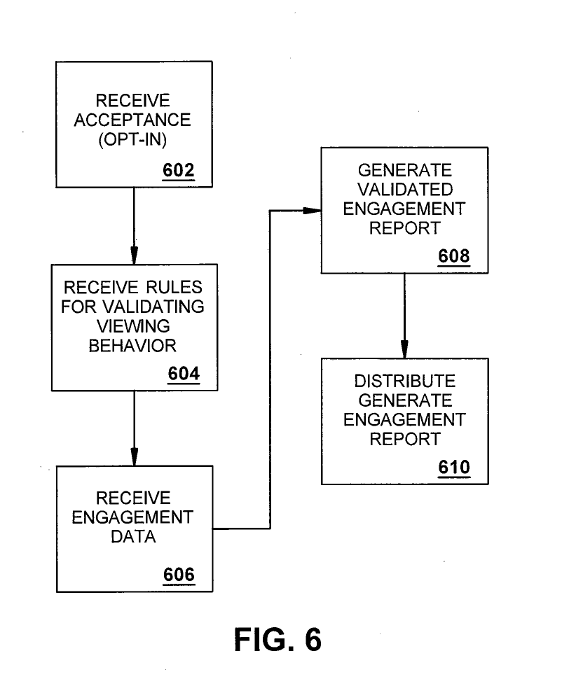

In view of the foregoing structural and functional features described above, a methodology in accordance with an example embodiment will be better appreciated with reference to FIG. 6. While, for purposes of simplicity of explanation, the methodology of FIG. 6 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology. The methodology described herein is suitably adapted to be implemented in hardware, software that implements the methodology when executed, or a combination thereof.

At 602, data is received indicating a subscriber has accepted (opted-in) to the loyalty program. In an example embodiment, a user may choose to join multiple brand loyalty award programs. In particular embodiments, a subscriber may be required to acknowledge that the subscriber is opting in to all loyalty programs associated with a loyalty program infrastructure.

At 604, rules for validating viewing behavior are received. The rules for validating viewing behavior may indicate under what circumstances a viewer is considered to have been engaged with the content.

For example, the rules for validating viewer engagement may specify whether a viewer is engaged based on a type of service, for example whether the media was viewed in real-time, via a digital video recorder (DVR) or video on demand (VOD). In particular embodiments, the rules for validating viewer engagement may include the type of device employed to view the media such as a television, personal computer (PC), mobile device (e.g., smart phone, laptop, or tablet computer), game console, etc.

In an example embodiment, the rules for validating viewer engagement comprise measurement data. For examples, the rules may specify that the viewer should be prompted at periodic or aperiodic intervals to confirm engagement with the content by displaying certain messages and requesting the viewer to provide a certain input (e.g., push the select button on a remote or press a specified function key on a computer keyboard). The rules may further specify interaction activities to confirm engagement activities such as whether there were requests to replay the content or requests made for other information. In particular embodiments, the rules may include specify how to process data representative of user sentiment. For example, data about associated chat activities such as amount and words used. In an example embodiment, the rules may validate promotional activities such as data indicating whether the viewer forwarded the content to friends or posted comments to a blog (web log).

For example, the rules for validating view engagement may specify whether a user is considered engaged if audio was muted or the display was minimized or obscured during play out of the media content. In addition, the validation data may comprise data indicating whether any media content was skipped or fast forwarded.

In an example embodiment, the rules for validating user engagement may specify aggregate behavior. For example, viewing of a predefined number of episodes may be required before points are awarded (for example no points awarded if viewing less than n episodes, points are awarded once n episodes are viewed). As another example, if the viewer skipped or fast forwarded over some content, whether the viewer should receive a partial engagement credit or be considered not engaged at all.

At 606, raw viewer engagement data is received from an end user device. The engagement data may include what content was viewed and/or what portions of the content were viewed. The engagement data may also include data indicating whether the audio was muted during any portion of the viewing period, whether the content was viewed in full screen mode, a minimized mode, or in a window less than the full display. The viewer engagement data may include data indicating that the viewer was prompted to perform an activity to indicate presence, whether the viewer actually performed the activity and/or how long it took the viewer to respond to the prompt. The viewer engagement data may comprise data indicating whether the viewer interacted with the program such as voting, social promotion, forwarding to acquaintances, filling out questionnaires, whether the viewer purchased media content, or other items associated with the content such as apparel, services, tickets, etc.

At 608, a validated engagement reports is generated. The validated engagement report is generated based upon the rules received at 604 applied to the engagement data received at 606. If validated engagement reports are being provided to a plurality of brand loyalty programs, a separate report is generated for each brand loyalty program based upon the appropriate rules for each brand loyalty program.

At 610, the validated engagement report is distributed. In the case of a single loyalty program, the validated engagement report is distributed to the Brand Awards Program Controller. If a plurality of validated engagement reports were generated at 608, then each validated engagement report is distributed to the appropriate Brand Awards Program Controller.

Although the preceding description of the example embodiments described user activity with respect to broadcast media such as television and/or audio visual media content, those skilled in the art should readily appreciate that the principles described herein should not be construed as limited to these types of media. For example, the principles described herein may be adapted to an audio only media such as radio and/or visual advertisements. Therefore, the example embodiments described herein should not be construed as being limited to any particular type of media.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
an interface for receiving a brand federated data report comprising data representative of a viewer engagement with pre-defined media content, and data indicating that the viewer forwarded the media content; and
an awards decision system for calculating award points based on the data representative of viewer engagement and data indicating that the viewer forwarded the media content;
wherein the viewer is a member of the loyalty program.

2. The apparatus of claim 1, wherein the brand federated data report further comprises data representative of a review posted by the viewer; and
wherein the awards decision system further considers the data representative of the review for calculating awards points.

3. The apparatus of claim 1, wherein the brand federated data report further comprises data representative of whether audio content was muted; and
wherein the awards decision system further considers the data representative of whether audio content was muted for calculating awards points.

4. The apparatus of claim 1, wherein the brand federated data report further comprises data indicating whether the media content was viewed in a full-screen mode; and
wherein the awards decision system further considers the data indicating whether the media content was viewed in a full-screen mode for calculating awards points.

5. The apparatus of claim 1, wherein brand federated data report further comprises receives data representative of competing media available during a time period when the media content was broadcast; and
wherein the awards decision system further considers the data representative of competing media available during the time period when the media content was broadcast for calculating awards points.

6. The apparatus of claim 1, wherein the brand federated data report further comprises data representative of a rating for the media content; and
wherein the awards decision system further considers the data representative of a rating for the media content for calculating awards points.

7. The apparatus of claim 1, wherein the brand federated data report further comprises a unique user identification for identifying the viewer of the content.

8. The apparatus of claim 1, wherein the interface receives brand federated reports from a plurality of service providers of pre-defined media; and
wherein the awards decision system further considers data from all of the brand federated reports for calculating awards points.

9. A method, comprising:
receiving data indicating a user is requesting to be included into a loyalty program, wherein the loyalty program includes a plurality of loyalty programs associated with a plurality of brands;
receiving from a Brand Awards Program Controller associated with a one of the plurality of loyalty programs data representative of rules for validating viewer behavior for each of the plurality of loyalty programs;
receiving a raw engagement report comprising data representative of user engagement with a pre-defined media;
generating by the validation filter, a first validated engagement report based on the data representative of media activity and first rules for validating view behavior associated with a first of the plurality of loyalty programs;
generating by the validation filter, a second validated engagement report based on the data representative of media activity and a second rules for validating view behavior associated with a second of the plurality of loyalty programs;
forwarding the first validated engagement report to a Brand Awards Program Controller associated with the first loyalty program; and
forwarding the second validated engagement report to a brand awards program controller associated with the second loyalty program.

10. The method of claim 9, further comprising receiving a unique user identifier for the user requesting to be included into the loyalty program;
wherein the same unique identifier is employed to identify the user with all of the plurality of loyalty programs.

11. The method of claim 9, further comprising receiving data verifying the user is acknowledging acceptance into all of the plurality of loyalty programs.

12. The method of claim 9, wherein the raw engagement report further comprises data indicating whether an audio component associated with the pre-defined media was muted.

13. The method of claim 9, wherein the raw engagement report further comprises an identifier for the content of the pre-defined media.

14. The method of claim 9, wherein the raw engagement report further comprises data indicating which portions of the media were engaged by the user.

15. The method of claim 9, further comprising determining federated brands associated with a first brand associated with the first loyalty program; and
disturbing the validated engagement report to the federated brands.

16. Logic encoded in a non-transitory computer readable medium for execution by a processor, and when executed by a processor operable to:
obtain data representative of viewer engagement with a pre-defined media content, the data representative of viewer engagement comprises data indicating a viewing mode employed to engage the pre-defined media;
calculating awards points based on the viewer engagement with the pre-defined media and the viewing mode.

17. The logic of claim 16, wherein the viewing mode is one of a full screen mode, a visible but less than full size mode, or a minimized mode;
wherein more awards points are awarded for full size mode than the visible but less than full size mode, and more awards points are awarded for the visible but less than full size mode than the minimized mode.

18. The logic of claim 16, wherein the data representative of viewer engagement with a predefined media content comprises data indicating whether audio associated with the pre-defined media content was muted.

19. The logic of claim 16, wherein the data representative of viewer engagement with the predefined media content comprises data representative of a type of device employed to engage with the predefined media content; and
wherein calculating awards points is further based on the type of device employed to engage with the predefined media content.

20. The logic of claim 16, wherein awards points are calculated for multiple brands based on viewer engagement with the same predefined media content.
